(19) United States
(12) Patent Application Publication
(10) Pub. No.: US 2011/0173472 A1
(43) Pub. Date: Jul. 14, 2011

(54) Graphic Controller, Information Processing Apparatus, and Power Saving Method

(76) Inventor: Yohzoh Ogura, Oume-shi (JP)

(21) Appl. No.: 12/874,593

(22) Filed: Sep. 2, 2010

(30) Foreign Application Priority Data
Jan. 8, 2010 (JP) 2010-003030

(51) Int. Cl. G06F 1/32

(52) U.S. Cl. 713/323

(57) ABSTRACT

According to one embodiment, there is provided a graphic controller to be employed in an information processing apparatus that is operable in a system state of either a normal mode or a power saving mode, the graphic controller including: an image processing section provided within a first power domain and configured to generate screen data based on data received from a control section of the information processing apparatus; and a VGA controller provided within a second power domain and configured to output the screen data to a display device, wherein, upon receiving information indicating a transition from the normal mode to the power saving mode, the VGA controller continues outputting the screen data having been outputted to the display device at the time of receiving the information to the display device, even after the transition to the power saving mode.

### CROSS-REFERENCE TO RELATED APPLICATION(S)

This application is based upon and claims the benefit of priority from Japanese Patent Application No. 2010-003030, filed on Jan. 8, 2010, the entire contents of which are incorporated herein by reference.

### FIELD

Embodiments described herein relate generally to: a graphic controller in which power necessary in display control is reduced; an information processing apparatus employing this graphic controller; and a power saving method for this graphic controller.

### BACKGROUND

For example, JP-2004-288087-A discloses techniques for reducing power necessary in display control.

JP-2004-288087-A discloses an information processing apparatus having a normal display mode and a power saving display mode, and has: a main control means that goes into an active state in a normal display mode so as to control general display means such as a liquid crystal display unit and that goes into a sleep state in a power saving display mode; and a power saving display control means that goes into an active state in a power saving display mode so as to control the display means and that goes into a sleep state in a normal display mode.

Each of the main control means and the power saving display control means has one graphic controller. Display control in a sleep state is performed by the dedicated power saving display control section, while the main control section causing a high power consumption is brought into a sleep state. Thus, according to this information processing apparatus, power necessary in display control in a sleep state is reduced.

In JP-2004-288087-A, two graphic controllers are required, thereby causing complexity in the configuration of the apparatus. Further, in JP-2004-288087-A, it is intended to be applied to a PDA (Personal Digital Assistant), a portable telephone, and the like, but not to an information processing apparatus such as a personal computer having a high-performance graphic controller.

Some graphic controllers have a video engine, a 2D/3D engine, or the like serving as a circuit for implementing the function of processing a video image or a three-dimensional image. When the such technique is to be implemented in a graphic controller of this kind, in display control in a sleep state as well as in display control for displaying a static image, power consumption is caused by the circuit for implementing those intrinsically unnecessary functions.

### BRIEF DESCRIPTION OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 generally illustrates an information processing apparatus employing a graphic controller and a power saving method according to an embodiment.

FIG. 2 exemplarily illustrates a block configuration of a personal computer.

FIG. 3 exemplarily illustrates a power domain in a graphic controller.

FIG. 4 exemplarily illustrates a difference in power consumption of a personal computer between the cases that a simple VGA function is ON and OFF.

FIG. 5 exemplarily illustrates a procedure for reducing power consumption in a graphic controller.

### DETAILED DESCRIPTION

In general, according to one embodiment, there is provided a graphic controller to be employed in an information processing apparatus that is operable in a system state of either a normal mode or a power saving mode, the graphic controller including: an image processing section provided within a first power domain and configured to generate screen data based on data received from a control section of the information processing apparatus, the first power domain being supplied with power in the normal mode while being not supplied with power in the power saving mode; and a VGA controller provided within a second power domain and configured to output the screen data to a display device, the second power domain being supplied with power regardless of whether the normal mode or the power saving mode, wherein, upon receiving information indicating a transition from the normal mode to the power saving mode, the VGA controller continues outputting the screen data having been outputted to the display device at the time of receiving the information to the display device, even after the transition to the power saving mode.

An embodiment of a graphic controller, an information processing apparatus, and a power saving method according to the present invention is described below with reference to the accompanying drawings.

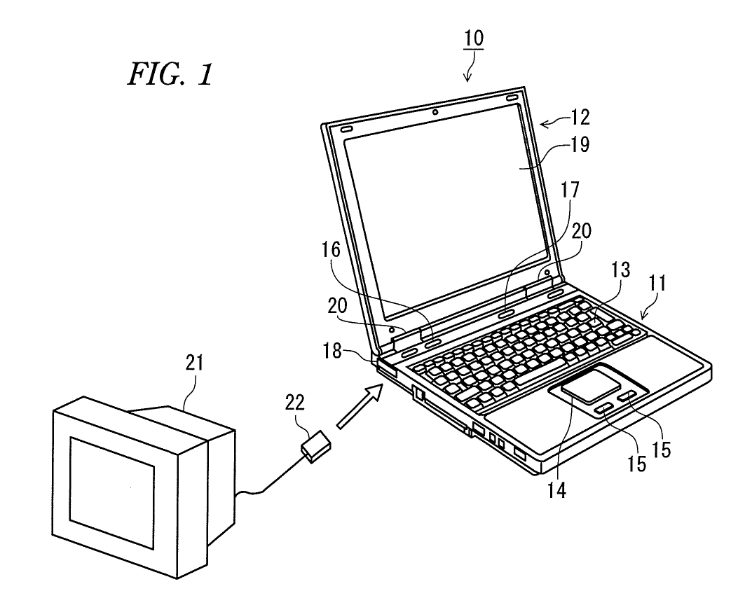

FIG. 1 generally illustrates an information processing apparatus employing a graphic controller and a power saving method according to an embodiment. In the embodiment, a personal computer of notebook type (referred to as a personal computer, hereinafter) is exemplified as the information processing apparatus.

As shown in FIG. 1, a personal computer 10 has a computer body 11 and a display unit 12 serving as a display device.

The computer body 11 has a thin-box-shaped chassis. Then, a keyboard 13 serving as a manipulation section is provided in the center part on the upper face of the chassis. A touchpad 14 and touchpad control buttons 15 are provided in the almost center part on the near side on the upper face of the chassis. And, a power button 16 for turning ON and OFF the power of the personal computer 10 and a power saving button 17 serving as a state transition instruction input section are arranged on the far side on the upper face of the chassis.

The power saving button 17 is used for receiving a user instruction instructing that the system state should be transit between an ordinary active state (a normal mode) and an active state (a power saving mode) in which power consumption is lower than in the normal mode. In a situation that the personal computer 10 is in a normal mode, when the power saving button 17 is pressed by a user, the system state transits to a power saving mode. In contrast, in a situation that the personal computer 10 is in a power saving mode, when the power saving button 17 is pressed by a user, the system state transits to a normal mode.

The power saving mode includes plural sub-modes like: a mode (referred to as a monitor OFF mode, hereinafter) in which the display device is turned OFF or alternatively brought into a waiting state of a reduced power consumption; and a so-called standby mode in which power supply to the volatile main storage device is continued but power supply to a majority of the other devices is stopped. One of these sub-modes is selected as a power saving mode in advance by user setting or by initial setting. When the power saving button 17 is pressed, then depending on the present system state, the system state of the personal computer 10 goes into the selected power saving mode or into a normal mode. The function of the power saving button 17 may be imparted to the power button 16. In this case, the power saving button 17 may be omitted.

Further, in transition from a normal mode to a power saving mode, the personal computer 10 according to the present embodiment has the function (referred to as a simple VGA (Video Graphics Array) function, hereinafter) of causing the display device to continue displaying the display screen having been displayed at the time of transition and still of reducing the power consumption of the graphic controller. It is assumed that whether the simple VGA function is to be used in a power saving mode is set up in advance by user setting or by initial setting.

In a case that the simple VGA function is set ON, when the power saving button 17 is pressed by a user in a normal mode, the system state of the personal computer 10 transits to a power saving mode employing a simple VGA function.

For example, in a case that the simple VGA function is set ON, in transition from a normal mode to a monitor OFF mode (a monitor OFF mode employing a simple VGA function), even after the OS recognizes completion of the transition to a monitor OFF mode, the personal computer 10 according to the present embodiment can continuously display the screen on the display device in a state that the power consumption of the graphic controller is reduced. In contrast, in a case that the simple VGA function is set OFF, in transition from a normal mode to a monitor OFF mode (a monitor OFF mode not employing a simple VGA function), after the OS recognizes completion of the transition to a monitor OFF mode, the screen data output to the display device remains stopped. Further, the display device is maintained in a power OFF state or in a waiting state.

A CRT jack 18 for connecting a CRT (Cathode Ray Tube) display (referred to as a CRT, hereinafter) 21 is arranged in a side surface of the chassis (computer body 11). The personal computer 10 outputs a video signal for the CRT display through the jack 18.

The display unit 12 has a display panel composed of an LCD (Liquid crystal display) 19 serving as a display device, and is linked through a linkage part (hinge) 20 so as to be supported by the computer body 11 in a manner permitting open and close.

The CRT 21 serving as a display device has a plug 22 and, when the plug 22 is inserted into the CRT jack 18, displays onto the display screen the video signal received from the personal computer 10.

The LCD 19 and the CRT 21 both have the function of, when a video signal is not received, automatically transiting to a power OFF state or to a waiting state where power consumption is reduced. Thus, in the personal computer 10, when the video signal output to the LCD 19 and the CRT 21 is stopped, the power consumption of the LCD 19 and the CRT 21 is reduced.

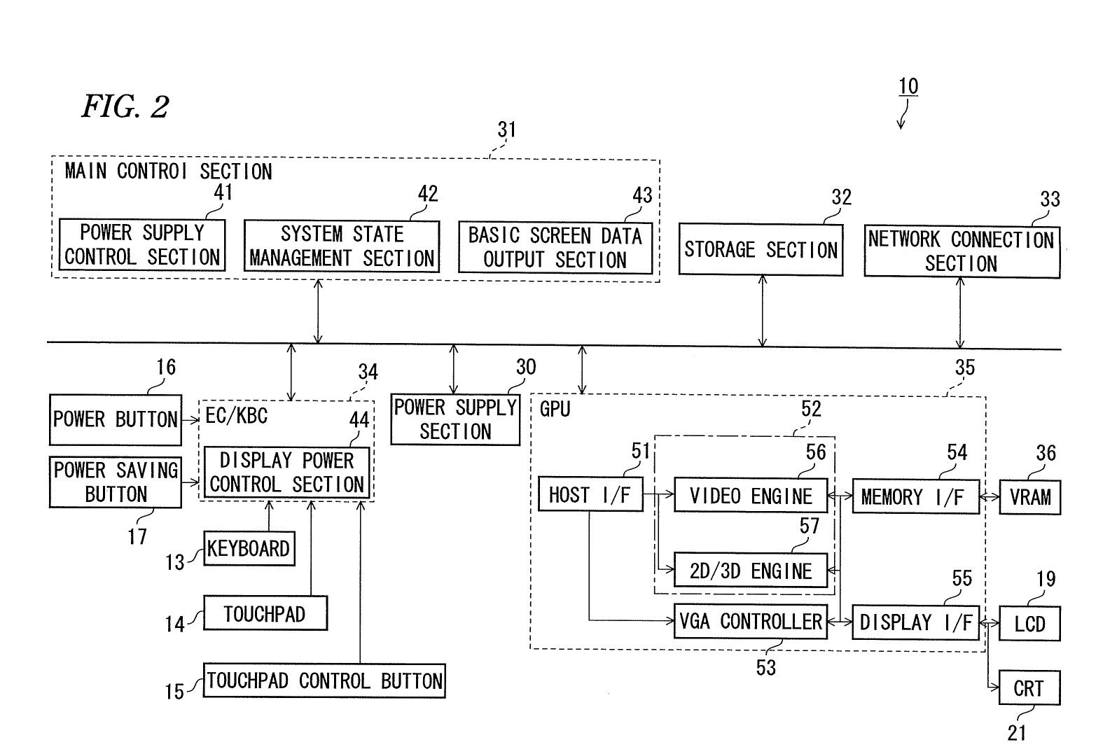

FIG. 2 exemplarily illustrates a block configuration of the personal computer 10.

The personal computer 10 has a keyboard 13, a touchpad 14, touchpad control buttons 15, a power button 16, a power saving button 17, an LCD 19, and a CRT 21, and further has a power supply section 30, a main control section 31, a storage section 32, a network connection section 33, an embedded controller/keyboard controller IC (EC/KBC) 34, a graphic controller (GPU) 35, and a VRAM (Video RAM) 36 serving as a video memory.

The power supply section 30 receives power from a source power supply or from a built-in battery (not shown), and then supplies power to various kinds of devices in the personal computer 10.

The main control section 31 is constructed from a CPU and storage media such as a RAM and a ROM. Then, in accordance with a program stored in the storage medium or the storage section 32, the main control section 31 controls the processing operation of the personal computer 10. The following description is given for an example that the CPU uses a program stored in the storage section 32.

The CPU of the main control section 31 loads, onto the RAM, data necessary for executing an operating system (referred to as an OS, hereinafter) or a program such as a digital book browsing program stored in the storage section 32, and then executes various kinds of processing in accordance with this program.

As shown in FIG. 2, the CPU serves as at least the power supply control section 41 and the system state management section 42 in accordance with the OS. Further, the CPU serves as at least a basic screen data output section 43 in accordance with various kinds of application programs such as the digital book browsing program. These sections 41 to 43 use a predetermined work area of the RAM as a temporary data storing area. These function implementation sections may be constructed from a hardware logic such as a circuit without the usage of the CPU.

The power supply control section 41 is controlled by the system state management section 42 in accordance with the system state, and controls the power supply section 30 in accordance with the system state so as to control power supply to the various kinds of devices in the personal computer 10. More specifically, in a normal mode, the power supply control section 41 supplies power to the various kinds of devices in the personal computer 10. Further, in transition from a normal mode to a monitor OFF mode, the power supply control section 41 continues power supply to the various kinds of devices. Furthermore, in transition from a normal mode to a standby mode, the power supply control section 41 basically stops power supply to the various kinds of devices except for the RAM of the main control section 31 and the EC/KBC 34.

In the embodiment, in transition from a normal mode to a standby mode, the power supply control section 41 continues power supply to the VRAM 36 in a so-called refresh mode. The refresh mode indicates a mode in which in order that that the stored information in the VRAM 36 should not evaporate, power supply and stop for the VRAM 36 are repeated periodically.

The system state management section 42 controls the power supply control section 41 in accordance with the system state. Further, the system state management section 42 controls the functions of the various kinds of devices including the GPU 35 in the personal computer 10, in accordance with the system state.

For example, in transition from a normal mode to a monitor OFF mode, the system state management section 42 instructs the GPU 35 to stop output of the screen data to the display device. As a result, after the transition from a normal mode to a monitor OFF mode, output of the screen data to the LCD 19 and the CRT 21 is stopped. Thus, the LCD 19 and the CRT 21 automatically transit to a power OFF state or to a waiting state where power consumption is reduced.

Further, in transition from a normal mode to a standby mode, the system state management section 42 instructs the power supply control section 41 to stop power supply to the various kinds of devices except for the RAM in the main control section 31, the EC/KBC 34, and the VRAM 36 (transiting to a refresh mode), so as to cause the system state to transit from a normal mode to a standby mode, and then provides information indicating the situation to the VGA controller 53. It is preferable that the VGA controller 53 holds information of the screen data presently outputted to the display device.

Description given above has been made for an exemplary case that the screen data displayed on the display device at the time of transition from a normal mode to a standby mode is stored into the VRAM 36. Instead, the EC/KBC 34, the VGA controller 53, or the like may be used. In a case that the screen data displayed on the display device at the time of transition from a normal mode to a standby mode is stored into the EC/KBC 34, when information indicating that the system state is to transit from a normal mode to a standby mode is provided to the VGA controller 53 from the system state management section 42, the screen data is read from the VRAM 36 by the VGA controller 53 and then stored into the EC/KBC 34. In this case, in a standby mode, the VRAM 36 need not receive power supply by a refresh mode.

In accordance with various kinds of programs, the basic screen data output section 43 generates data (referred to as basic screen data, hereinafter) to be displayed on the display device, and then outputs the generated data to the GPU 35. For example, when a digital book browsing program is executed, the basic screen data output section 43 outputs, to the GPU 35, basic screen data having the contents of a predetermined page in a predetermined book.

The RAM of the main control section 31 provides a work area for temporarily storing data, to the program executed by the CPU.

The storage media including the ROM of the main control section 31 and the storage section 32 has a configuration provided with a CPU-readable recording medium such as a magnetic or optical recording medium and a semiconductor memory. Then, all or part of the programs and the data in these storage media may be downloaded through an electronic network.

The storage section 32 stores the start program and the OS for the personal computer 10, a digital book browsing program, and various kinds of data necessary in the execution of these programs.

The network connection section 33 implements various kinds of protocols for information communication corresponding to the network mode. In accordance with these protocols of various kinds, the network connection section 33 connects the personal computer 10 to other electronic devices. This connection may be implemented by electric connection through an electronic network or the like. The electronic network mentioned here indicates a generic information communication network employing a telecommunication technique, and may be a wireless/cable LAN (Local Area Network), the Internet network, a telephone communication line network, an optic fiber communication network, a cable communication network, a satellite communication network, or the like.

The EC/KBC 34 is a one-chip microcomputer serving as a controller for controlling the keyboard 13 as a key input section, the touchpad 14, the touchpad control buttons 15, the power button 16, and the power saving button 17. The EC/KBC 34 serves also as the display power control section 44.

When the simple VGA function is ON, the display power control section 44 controls power supply to the GPU 35 in a power saving mode. The function of the display power control section 44 may be included in the function of the CPU of the VGA controller 53 or the main control section 31.

As shown in FIG. 2, the GPU 35 has a host interface circuit (host I/F) 51, an image processing section 52, a VGA (Video Graphics Array) controller 53, a memory interface circuit (memory I/F) 54, and a display interface circuit (display I/F) 55.

The host I/F 51 receives data from the CPU of the main control section 31, and then provides the data to at least any one of the image processing section 52 and the VGA controller 53. For example, the host I/F 51 receives the basic screen data from the basic screen data output section 43, and then provides the data to the image processing section 52. When power supply to the host I/F 51 is stopped, the GPU 35 cannot receive basic screen data from the CPU of the main control section 31.

The image processing section 52 is constructed from hardware such as a general video engine 56 and a 2D/3D engine 57. Based on basic screen data, the image processing section 52 generates screen data to be displayed on the display device, and then stores the data into the VRAM 36.

The VGA controller 53 reads via the memory I/F 54 the screen data stored in the VRAM 36, and then outputs the read-out data through the display I/F 55 to the LCD 19 and the CRT 21. When the simple VGA function is ON, when receiving information indicating that the system state is to transit from a normal mode to a power saving mode (for example, in the case of transition to a monitor OFF mode, an instruction indicating that output of screen data to the display device should be stopped), the VGA controller 53 continues outputting screen data having been outputted to the display device at the time of receiving the information, to the display device even after the transition to the power saving mode.

For example, when the simple VGA function is OFF, after the transition from a normal mode to a monitor OFF mode, the display device maintains a power OFF state or a waiting state. In contrast, when the simple VGA function is ON, after the transition from a normal mode to a monitor OFF mode, the OS recognizes that the system state is in a monitor OFF mode, whereas when the VGA controller 53 restarts output of the screen data, the display device restarts display of the screen data.

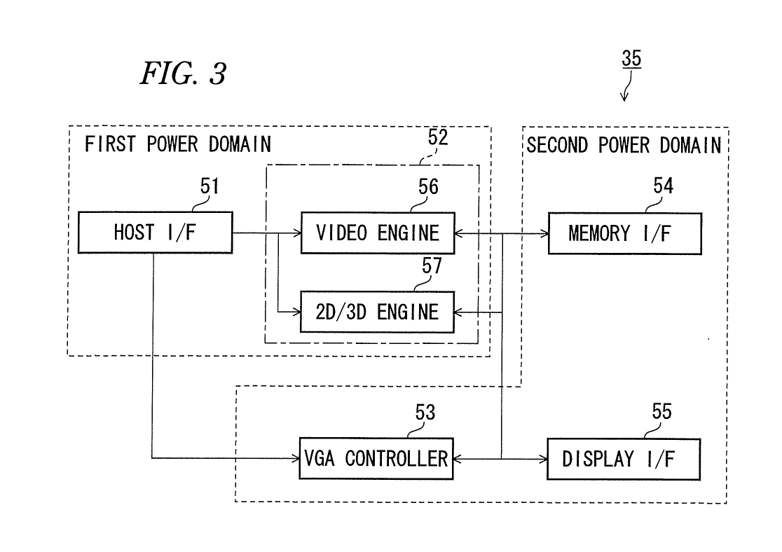

FIG. 3 exemplarily illustrates the power domain in the GPU 35.

As shown in FIG. 3, the power domain in the GPU 35 according to the present embodiment is constructed from a first power domain and a second power domain. The first power domain covers the host I/F 51 and the image processing section 52. The second power domain covers the VGA controller 53, the memory I/F 54, and the display I/F 55.

In each power domain, when the display power control section 44 controls the power supply section 30, power supply is performed separately. Specifically, in a normal mode, power is supplied in the two power domains. In contrast, when the simple VGA function is set ON, in a power saving mode, power is supplied only in the second power domain, while power supply is stopped in the first power domain.

Thus, in a power saving mode employing a simple VGA function, power supply to the host I/F 51 and the image processing section 52 is stopped. Thus, when power supply to the host I/F 51 is stopped, the GPU 35 cannot receive basic screen data from the CPU of the main control section 31. As a result, new screen data is not saved into the VRAM 36. Thus, the information at the time of transition from a normal mode to a power saving mode is maintained as the stored information in the VRAM 36.

Further, in transition from a normal mode to a monitor OFF mode, the system state management section 42 instructs the GPU 35 to stop output of the screen data to the display device. As a result, the OS recognizes completion of the transition to a monitor OFF mode. On the other hand, after the transition to a power saving mode employing a simple VGA function, the display power control section 44 controls and causes the power supply section 30 to supply power to the second power domain and to stop power supply to the first power domain.

That is, after the transition from a normal mode to a power saving mode employing a simple VGA function, the information at the time of transition from a normal mode to a power saving mode is maintained as the stored information in the VRAM 36. Further, the VGA controller 53, the memory I/F 54, and the display I/F 55 receive power supply and hence operate normally. Thus, when new screen data need not be generated, the simple VGA function is used so that power supply to the first power domain is stopped. This reduces the power consumption of the GPU 35, and still allows the predetermined image to be displayed on the display device by using the screen data stored into the VRAM 36 at the time of transition from a normal mode to a power saving mode.

Here, difference in the power consumption between the cases that the simple VGA function is ON and OFF is described below.

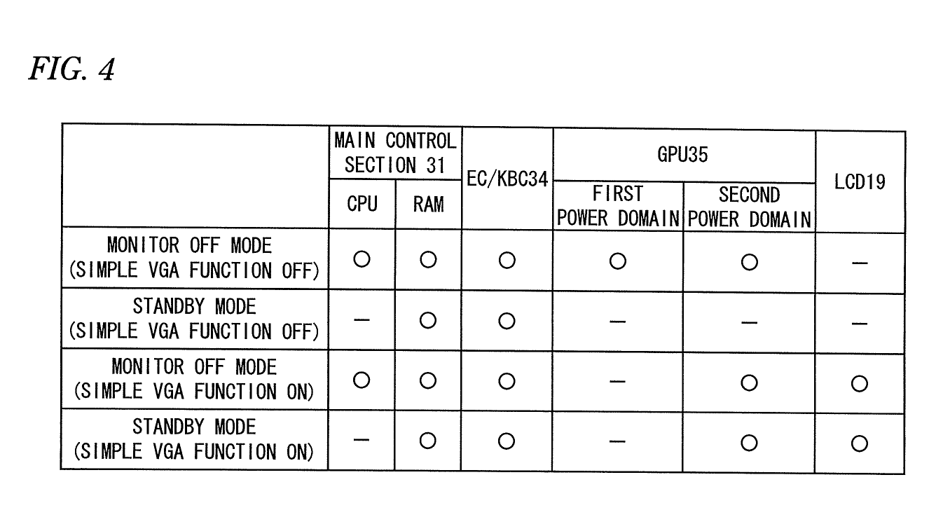

FIG. 4 exemplarily illustrates a difference in the power consumption of the personal computer 10 between the cases that the simple VGA function is ON and OFF. In FIG. 4, symbol “◯” specifies a device to which power is supplied in each mode, while symbol “-” specifies a device in which power supply is stopped in each mode.

When the simple VGA function is OFF, at the time of transition from a normal mode to a power saving mode, the system state management section 42 serving as a CPU function implementation section in the OS instructs the VGA controller 53 to stop output of the screen data to the display device. As a result, the OS recognizes completion of the transition to a monitor OFF mode, and the LCD 19 serving as a built-in display device (and the CRT 21 serving as an external display device) automatically transits to a power OFF state or to a waiting state where power consumption is reduced.

In this case, after the transition from a normal mode to a power saving mode, the VGA controller 53 does not output the screen data to the display device. Thus, the display device remains in a power OFF state or in a waiting state of a reduced power consumption.

Further, as shown in FIG. 4, when the simple VGA function is OFF, at the time of transition from a normal mode to a monitor OFF mode, power supply to the first power domain and the second power domain is continued despite that screen data output to the display device is unnecessary.

In contrast, when the simple VGA function is ON, the GPU 35 receives power supply control by the display power control section 44. When the simple VGA function is ON, after the transition to a power saving mode, in the GPU 35, power supply is stopped to the first power domain including the image processing section 52, while power is supplied to the second power domain composed of devices indispensable for the continuation of outputting the screen data having been outputted to the display device at the time of transition from a normal mode to a power saving mode, to the display device even after the transition to a power saving mode.

For example, when the simple VGA function is ON, at the time of transition from a normal mode to a monitor OFF mode, first, similarly to the case that the simple VGA function is OFF, the system state management section 42 serving as a CPU function implementation section in the OS instructs the VGA controller 53 to stop output of the screen data to the display device. As a result, the OS recognizes completion of the transition to a monitor OFF mode, and the LCD 19 serving as a built-in display device (and the CRT 21 serving as an external display device) automatically transits to a power OFF state or to a waiting state where power consumption is reduced.

When the simple VGA function is ON, after the transition from a normal mode to a monitor OFF mode, the display power control section 44 controls and causes the power supply section 30 to continue power supply to the second power domain and to stop power supply to the first power domain. Then, the VGA controller 53 reads via the memory I/F 54 the screen data stored in the VRAM 36, and then outputs the read-out data through the display I/F 55 to the LCD 19 and the CRT 21.

As a result, when the simple VGA function is ON, the VGA controller 53 can continuously display the screen on the display device even after the OS recognizes completion of the transition to a monitor OFF mode.

Thus, as seen from FIG. 4, when the simple VGA function is ON, in comparison with the case that the simple VGA function is OFF, the power consumption in the image processing section 52 can reliably be reduced after the transition from a normal mode to a monitor OFF mode. Further, when the simple VGA function is ON, power is supplied to the second power domain even after the transition to a power saving mode. Thus, also in a power saving mode, the screen data having been outputted to the display device at the time of transition from a normal mode to a power saving mode is outputted to the display device.

Next, an exemplary case is described that the screen data having been outputted to the display device at the time of transition from a normal mode to a power saving mode is continuously outputted to the display device even after the transition to a power saving mode employing a simple VGA function, like a case that new screen data need not be generated.

An exemplary case is considered that in a normal mode, a user reads a predetermined page of a digital book by using a digital book browsing program. In this case, when the power saving button 17 is pressed by the user so that the system state transits to a monitor OFF mode employing a simple VGA function, first, as a result of the control of the system state management section 42, output of the screen data to the LCD 19 or the CRT 21 is stopped temporarily. Thus, the LCD 19 or the CRT 21 automatically transits to a power OFF state or to a waiting state where power consumption is reduced. Then, the VGA controller 53 receives, from the EC/KBC 34, information indicating that the system state is to transit from a normal mode to a monitor OFF mode. Thus, the VGA controller 53 reads the screen data having been displayed on the display device from the VRAM 36 at the time of transition from a normal mode to a monitor OFF mode, and then continues outputting the screen data to the display device again. As a result, the display device receives the screen data again, and thereby goes into a normal active state so as to continue displaying the received screen data (the screen data having been displayed on the display device at the time of transition from a normal mode to a monitor OFF mode).

In a monitor OFF mode, power supply to the various kinds of devices in the personal computer 10 is maintained. Thus, the user visually recognizes the same screen as that displayed before the transition to a monitor OFF mode. Further, the processing whose execution has been instructed to the personal computer 10 before the transition to a monitor OFF mode is executed continuously (executed in the background). Processing of this kind includes music reproduction, program compilation, data download from an electronic network, and various kinds of calculation.

In a case that a user reads a predetermined page of a digital book by using a digital book browsing program, the screen data is a static image. Thus, in many cases, the function of the image processing section 52 is unnecessary. In such cases, according to the personal computer 10 of the present embodiment, the user presses the power saving button 17 so as to cause transition to a monitor OFF mode employing a simple VGA function or to a standby mode. By virtue of this, in a state that the predetermined page of the digital book is displayed on the display device, power supply to the image processing section 52 is stopped so that useless power supply to the image processing section 52 is avoided.

During the browsing of the digital book in a power saving mode, the user desires page feed occasionally. For the purpose of satisfy this requirement, a page feed function in a power saving mode may be assigned to a predetermined input section such as the keyboard 73 and the touchpad control buttons 15. Further, for example, a “digital book browsing mode” may be defined as a state selectable as a sub-mode of the power saving mode. Then, when the power saving button 17 is pressed, the system state transits to a monitor OFF mode employing a simple VGA function (or a standby mode), and then the page feed function in a power saving mode may be assigned to a predetermined input section (such as a key).

The digital book browsing mode is a power saving mode obtained by combining a monitor OFF mode employing a simple VGA function or a standby mode with the assignment of a page feed function to a predetermined input section (such as key). The following description is given for an example that the digital book browsing mode is a power saving mode obtained by combining a monitor OFF mode employing a simple VGA function, with the assignment of a page feed function to a predetermined input section (such as key) (referred to as a digital book browsing mode employing a monitor OFF mode, hereinafter).

The “page feed function in a power saving mode” indicates the function that: a power saving mode is canceled so that the system state transits to a normal mode, and hence power supply to the first power domain is restored; then, the screen data of a predetermined page of the digital book (the subsequent page in the case of forward page feed, the preceding page in the case of backward page feed, or the page of destination in the case of page skipping) is stored into the VRAM 36; and then, in a state that the system state transits to a power saving mode again, the screen data newly stored in the VRAM 36 is displayed on the display device. Obviously, in a case that the screen data of the subsequent page desired by the user is already stored in the VRAM 36, the page feed is achieved without the necessity of cancelation of a power saving mode.

For the purpose of implementation of the “page feed function in a power saving mode”, for example, a configuration is adopted that the VGA controller 53 executes a predetermined program so as to serve as a “digital book browsing mode implementation section”. In a case that a digital book browsing mode employing a monitor OFF mode is set up as a power saving mode, when the power saving button 17 is pressed, the digital book browsing mode implementation section assigns a page feed function to a predetermined key. Then, when the predetermined key is pressed, the digital book browsing mode implementation section may notify, to the system state management section 42, information indicating that temporary transition to a normal mode for the page feed and re-transition to a power saving mode after the necessary screen data is stored into the VRAM 36 are to be performed.

Here, regardless of whether the digital book browsing mode employs a monitor OFF mode or a standby mode, when the power saving button 17 is pressed in a digital book browsing mode, the system state transits to a normal mode. Further, in a digital book browsing mode, for the purpose of avoiding user's confusion, it is preferable that information indicating a digital book browsing mode is superposed onto the screen data on the display device.

Next, an example of operation of the graphic controller and the information processing apparatus according to the present embodiment is described below.

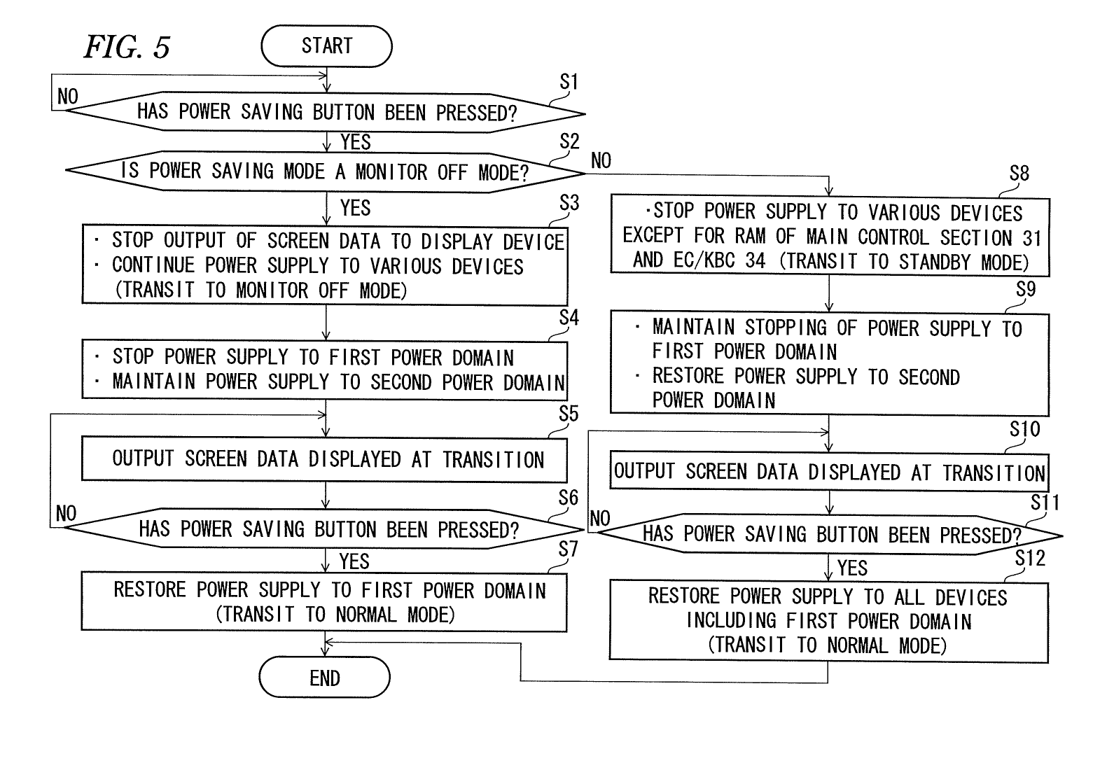

FIG. 5 exemplarily illustrates a procedure for reducing power consumption in the graphic controller. In FIG. 5, each symbol generated by adding a numeric character to an alphabet S indicates a step number in the flow chart. In the following description, either a monitor OFF mode or a standby mode is set up as a power saving mode, and in transition from a normal mode to a standby mode, the power supply control section 41 continues power supply to the VRAM 36 in a so-called refresh mode.

This procedure is started in a condition that the simple VGA function is set ON and that the system state is in a normal mode.

First, at step S1 the EC/KBC 34 determines whether the power saving button 17 has been pressed. When the power saving button 17 has been pressed, the procedure goes to step S2. In contrast, when the power saving button 17 is not pressed, the EC/KBC 34 continues monitoring the pressing of the power saving button 17.

Then, at step S2, the system state management section 42 determines whether a monitor OFF mode is set up as a power saving mode by user setting or by initial setting. When a monitor OFF mode is set up, the procedure goes to step S3. In contrast, when a standby mode is set up, the procedure goes to step S8.

Then, at step S3, the system state management section 42 instructs the GPU 35 to stop output of the screen data to the display device so as to cause the system state to transit from a normal mode to a monitor OFF mode, and then provides information indicating the situation to the VGA controller 53. It is preferable that the VGA controller 53 holds information of the screen data presently outputted to the display device. As a result, the OS recognizes completion of the transition to a monitor OFF mode. Further, in transition from a normal mode to a monitor OFF mode, the power supply section 30 continues power supply to the various kinds of devices.

Then, at step S4, the display power control section 44 performs power supply control on the GPU 35 such that power supply to the first power domain is stopped while power supply to the second power domain is continued.

Then, at step S5, the VGA controller 53 reads from the VRAM 36 the screen data having been outputted to the display device at the time of transition from a normal mode to a monitor OFF mode, and then outputs the read-out data to the display device again.

Then, at step S6 the EC/KBC 34 determines whether the power saving button 17 has been pressed. When the power saving button 17 has been pressed, the procedure goes to step S7. In contrast, when the power saving button 17 is not pressed, the procedure returns to step S5.

Then, at step S7, the display power control section 44 restores power supply to the first power domain, and then terminates the power supply control for the GPU 35. Further, the system state management section 42 instructs the GPU 35 to start output of the screen data to the display device. As a result, the system state transits from a monitor OFF state to a normal mode, and hence a series of the procedures are completed.

In contrast, at step S2, when it is determined that a monitor OFF mode is not set up as a power saving mode, that is, when it is determined that a standby mode is set up as a power saving mode, the system state management section 42 at step S8 instructs the power supply control section 41 to stop power supply to the various kinds of devices except for the RAM in the main control section 31, the EC/KBC 34, and the VRAM 36 (transiting to a refresh mode), so as to cause the system state to transit from a normal mode to a standby mode, and then provides information indicating the situation to the VGA controller 53. It is preferable that the VGA controller 53 holds information of the screen data presently outputted to the display device. As a result, the OS recognizes completion of the transition to a standby mode.

Then, at step S9, the display power control section 44 restores power supply to the second power domain. At that time, power supply to the first power domain remains stopped.

Then, at step S10, the VGA controller 53 reads from the VRAM 36 the screen data having been outputted to the display device at the time of transition from a normal mode to a standby mode, and then outputs the read-out data to the display device again.

Then, at step S11 the EC/KBC 34 determines whether the power saving button 17 has been pressed. When the power saving button 17 has been pressed, the procedure goes to step S12. In contrast, when the power saving button 17 is not pressed, the procedure returns to step S10.

Then, at step S12, the display power control section 44 restores power supply to the first power domain, and then terminates the power supply control for the GPU 35. Further, the system state management section 42 instructs the power supply control section 41 to start power supply to the various kinds of devices in the personal computer 10. As a result, the system state transits from a standby state to a normal mode, and hence a series of the procedures are completed.

Here, at step S12, restoration of power supply to the first power domain performed by the display power control section 44 may be omitted. This is because in transition from a standby mode to a normal mode, based on the instruction from the system state management section 42, the power supply control section 41 restores, via the power supply section 30, power supply to the various kinds of devices including the first power domain in the GPU 35 in the personal computer 10.

As a result of the above-mentioned procedure, in a case that the function of the image processing section 52 is not necessary, especially, like in a situation that a static image is displayed continuously, power supply to the first power domain including the image processing section 52 is stopped so that the power necessary in display control of the GPU 35 is reduced easily.

According to the personal computer 10 employing the GPU 35 of the present embodiment, in a case that the function of the image processing section 52 is not necessary, especially, like in a situation that a static image is displayed continuously, power supply to the first power domain is stopped so that the power consumption of the GPU 35 is reduced. And still, the screen data having been outputted to the display device at the time of transition from a normal mode to a power saving mode is continuously outputted to the display device even after the transition to a power saving mode.

Further, the personal computer 10 employing the GPU 35 according to the present embodiment uses a “monitor OFF mode” and a “standby mode” which are power saving modes implemented by the function of a general OS. Further, the operation of such transition between a normal mode and a power saving mode and the operation performed after the transition to a power saving mode which are implemented by the OS are independent of the operation of power system control for the GPU 35 performed by the display power control section 44 after the transition to a power saving mode. Thus, the GPU 35 according to the present embodiment easily cooperates with a general OS, and hence is easily applied to a general information processing apparatus.

The present invention is not limited to the exact embodiment given above, and may be implemented with modification of the components without deviation from the spirit of the present invention. Further, the plural components disclosed in the embodiment given above may be combined appropriately so that various kinds of inventions may be constructed. For example, some components may be omitted from the entirety of the components described in the embodiment.

For example, the present invention may be applied to an information processing apparatus of diverse kind other than the personal computer 10 of notebook type described in the embodiment given above. In particular, the present invention may be applied to a portable information processing apparatus such as a PDA (Personal Digital Assistant), a portable game machine, a portable music reproduction machine, and a portable video reproduction machine.

In the embodiment, the individual steps in the flow chart are executed sequentially in the described order. However, execution of the steps is not limited to sequential, and may be parallel or separate.

According to the graphic controller, the information processing apparatus, and the power saving method of the embodiment, power necessary in display control is reduced.

What is claimed is:

1. A graphic controller to be employed in an information processing apparatus that is operable in a system state of either a normal mode or a power saving mode, the graphic controller comprising:
an image processing section provided within a first power domain and configured to generate screen data based on data received from a control section of the information processing apparatus, the first power domain being supplied with power in the normal mode while being not supplied with power in the power saving mode; and
a VGA controller provided within a second power domain and configured to output the screen data to a display device, the second power domain being supplied with power regardless of whether the normal mode or the power saving mode,
wherein, upon receiving information indicating a transition from the normal mode to the power saving mode, the VGA controller continues outputting the screen data having been outputted to the display device at the time of receiving the information to the display device, even after the transition to the power saving mode.

2. The graphic controller of claim 1, further comprising:
a host interface circuit provided within the first power domain and configured to receive the data from the control section of the information processing apparatus and to provide the received data to at least one of the image processing section and the VGA controller;
a memory interface circuit provided within the second power domain and configured to mediate transmission/reception of the screen data between the image processing section and a video memory and between the video memory and the VGA controller; and
a display interface circuit provided within the second power domain and configured to mediate transmission/reception of the screen data between the VGA controller and the display device.

3. The graphic controller of claim 1,
wherein, when the information processing apparatus transits from the normal mode to the power saving mode, while output of the screen data to the display device is temporarily stopped, power supply to respective components of the information processing apparatus is continued to make functions thereof available by a power supply control section of the information processing apparatus, and
wherein, upon receiving the information indicating the transition of the information processing apparatus from the normal mode to the power saving mode, the VGA controller temporarily stops output of the screen data to the display device by a system state management section of the information processing apparatus, and after the transition, continues outputting of the screen data having been outputted at the time of receiving the information.

4. The graphic controller of claim 2,
wherein the power saving mode is a standby mode,
wherein, when the information processing apparatus transits from the normal mode to the power saving mode, power supply to the VGA controller, the memory interface circuit and the display interface circuit is restored by a display power control section of the information processing apparatus after being stopped by the power supply control section of the information processing apparatus,
wherein, in the power saving mode, power is periodically supplied to the video memory to hold the screen data stored in a volatile manner, and
wherein, upon receiving the information indicating the transition of the information processing apparatus from the normal mode to the power saving mode, when power supply is restored by the display power control section due to the transition, the VGA controller reads from the video memory the screen data having been outputted to the display device at the time of receiving the information to thereby continue outputting the screen data to the display device.

5. An information processing apparatus that is operable in a system state of either a normal mode or a power saving mode, the information processing apparatus comprising:
a basic screen data output section configured to output data to be displayed on a display device;
a graphic controller configured to generate screen data based on the data received from the basic screen data output section and to output the screen data to the display device;
a display power control section configured to control power supply to the graphic controller; and
a state transition instruction input section configured to receive a user instruction that instructs a transition of the information processing apparatus between the normal mode and the power saving mode,
wherein the graphic controller comprises:
an image processing section provided within a first power domain and configured to generate screen data based on data received from the basic screen data output section, the first power domain being supplied with power in the normal mode while being not supplied with power in the power saving mode by the display power control section; and
a VGA controller provided within a second power domain and configured to output the screen data to the display device, the second power domain being supplied with power regardless of whether the normal mode or the power saving mode by the display power control section, and
wherein, upon receiving information indicating a reception of the user instruction that instructs the transition from the normal mode to the power saving mode by the state transition instruction input section, the VGA controller continues outputting the screen data having been outputted to the display device at the time of receiving the information to the display device, even after the transition to the power saving mode.

6. The information processing apparatus of claim 5,
wherein the graphic controller further comprises:
a host interface circuit provided within the first power domain and configured to receive the data from the basic screen data output section and to provide the received data to at least one of the image processing section and the VGA controller;
a memory interface circuit provided within the second power domain and configured to mediate transmission/reception of the screen data between the image processing section and a video memory and between the video memory and the VGA controller; and
a display interface circuit provided within the second power domain and configured to mediate transmission/reception of the screen data between the VGA controller and the display device.

7. The information processing apparatus of claim 5, further comprising:
a power supply control section configured to control power supply to respective components of the information processing apparatus in accordance with the system state; and
a system state management section configured to control functions of the respective components in accordance with the system state at present,
wherein, when the information processing apparatus transits from the normal mode to the power saving mode, while output of the screen data to the display device is temporarily stopped, the poser supply control section continues power supply to the respective components to make the functions thereof available, and
wherein, upon receiving the information indicating a reception of the user instruction that instructs the transition from the normal mode to the power saving mode by the state transition instruction input section, the VGA controller temporarily stops output of the screen data to the display device by the system state management section, and after the transition, continues outputting of the screen data having been outputted at the time of receiving the information.

8. The information processing apparatus of claim 6,
wherein the power saving mode is a standby mode,
wherein, when the information processing apparatus transits from the normal mode to the power saving mode, power supply to the VGA controller, the memory interface circuit and the display interface circuit is restored by the display power control section after being stopped by the power supply control section,
wherein, in the power saving mode, power is periodically supplied to the video memory to hold the screen data stored in a volatile manner by the power supply control section, and
wherein, upon receiving the information indicating a reception of the user instruction that instructs the transition from the normal mode to the power saving mode by the state transition instruction input section, when power supply is restored by the display power control section due to the transition, the VGA controller reads from the video memory the screen data having been outputted to the display device at the time of receiving the information to thereby continue outputting the screen data to the display device.

9. A power saving method for a graphic controller to be employed in an information processing apparatus that is operable in a system state of either a normal mode or a power saving mode,
the graphic controller comprising:
an image processing section configured to generate screen data based on data received from a control section of the information processing apparatus; and
a VGA controller configured to output the screen data to a display device,
the power saving method comprising:
in the normal mode, supplying power to respective components of the graphic controller to make functions thereof available;
after a transition from the normal mode to the power saving mode, stopping power supply at least to the image processing section;
after a transition from the normal mode to the power saving mode, supplying power at least to the VGA controller; and
continuing outputting the screen data having been outputted to the display device at the time of the transition, from the VGA controller to the display device, even after the transition.

10. The power saving method of claim 9,
wherein the graphic controller further comprises:
a host interface circuit configured to receive the data from the control section of the information processing apparatus and to provide the received data to at least one of the image processing section and the VGA controller;
a memory interface circuit configured to mediate transmission/reception of the screen data between the image processing section and a video memory and between the video memory and the VGA controller; and
a display interface circuit configured to mediate transmission/reception of the screen data between the VGA controller and the display device,
wherein, in the step of stopping power supply at least to the image processing section, power supply to the host interface circuit is also stopped, and
wherein, in the step of supplying power at least to the VGA controller, power is also supplied to the memory interface circuit and the display interface circuit.
